(19) United States
(12) Patent Application Publication
(10) Pub. No.: US 2025/0042343 A1
(43) Pub. Date: Feb. 6, 2025

(54) MOUNTING ARRANGEMENT FOR A VEHICLE SENSOR

(71) Applicant: ZF Passive Safety Systems US Inc., Washington, MI (US)

(72) Inventors: Thomas E. Blake, III, Novi, MI (US); Robert James Newton, Chesterfield, MI (US); Anthony Rivas, Royal Oak, MI (US); Narahari Bharath, Farmington Hills, MI (US); Gregory Ratcliffe, Taylor, MI (US); Luis Castro Solis, Troy, MI (US); Sanket Zinjad, Dearborn, MI (US)

(21) Appl. No.: 18/790,421

(22) Filed: Jul. 31, 2024

Related U.S. Application Data
(60) Provisional application No. 63/516,630, filed on Jul. 31, 2023.

(51) Int. Cl. B60R 11/04; H04N 23/54

(52) U.S. Cl. CPC B60R 11/04; H04N 23/54

(57) ABSTRACT

A mounting arrangement for a vehicle sensor, comprising a housing and a mounting bracket. The housing has a vehicle sensor mounted therein and the housing has at least one mounting element. The mounting bracket includes at least one locking arm that includes a slot for receiving the at least one mounting element. The slot includes a V-shaped notch therein to retain the at least one mounting element within the slot.

### TECHNICAL FIELD

The present disclosure relates to a mounting arrangement for a vehicle sensor arrangement, such as a driver assist system, and more specifically, to a mounting arrangement for a vehicle sensor arrangement that is mounted to a vehicle window.

### BACKGROUND

Vehicle sensor arrangements such as a driver assist system, that use a camera to monitor the environment surrounding the vehicle are known. For example, one known type of driver assist system monitors an area in front of the vehicle and uses a forward looking camera. It is known to mount a forward looking camera to a front windshield of the vehicle. Such a forward looking camera can aid a driver in the operation of a motor vehicle by providing operational information such as a potential collision, lane or roadway departure, location of pedestrians, road sign information, etc. Camera systems could also be mounted to other vehicle locations such as the rear window. Data from the forward looking camera may be provided to other vehicle systems to provide the driver with a warning, haptic or tactile feedback, and/or autonomous control of the vehicle.

### SUMMARY

In one exemplary arrangement, a mounting arrangement for a vehicle sensor, comprising a housing and a mounting bracket is disclosed. The housing has a vehicle sensor mounted therein and the housing has at least one mounting element. The mounting bracket includes at least one locking arm that includes a slot for receiving the at least one mounting element. The slot includes a V-shaped notch therein to retain the at least one mounting element within the slot. The V-shaped notch allows for relaxed tolerances in designing a retention mechanism for securing the vehicle sensor to the mounting bracket.

### BRIEF DESCRIPTION OF THE DRAWINGS

The foregoing and other features and advantages of the present disclosure will become apparent to those skilled in the art to which the present disclosure relates upon reading the following description with reference to the accompanying drawings, in which:

FIG. 1 shows a perspective view of an exemplary arrangement of a portion of a vehicle sensor arrangement showing an exemplary engagement arrangement;

FIG. 2 is an enlarged view of an exemplary arrangement of an engagement element;

FIG. 3A is a schematic side view of an exemplary arrangement of a forward end of a mounting bracket configured to receive the engagement element of the vehicle sensor arrangement of FIG. 1;

FIG. 3B is a schematic side view of an exemplary arrangement of a rearward end of the mounting bracket of FIG. 3A, configured to receive mounting elements of the vehicle sensor arrangement;

FIG. 4 is a schematic side view of the engagement element being engaged with the forward end of the mounting bracket of FIG. 3A;

FIG. 5 is a schematic side view of an alternative exemplary arrangement of an engagement slot with a mounting bracket;

FIG. 6 is a schematic side view of a further alternative exemplary arrangement of an engagement slot for a mounting bracket; and

FIG. 7 is a schematic side view of a still further exemplary arrangement of an engagement slot for a mounting bracket.

### DETAILED DESCRIPTION

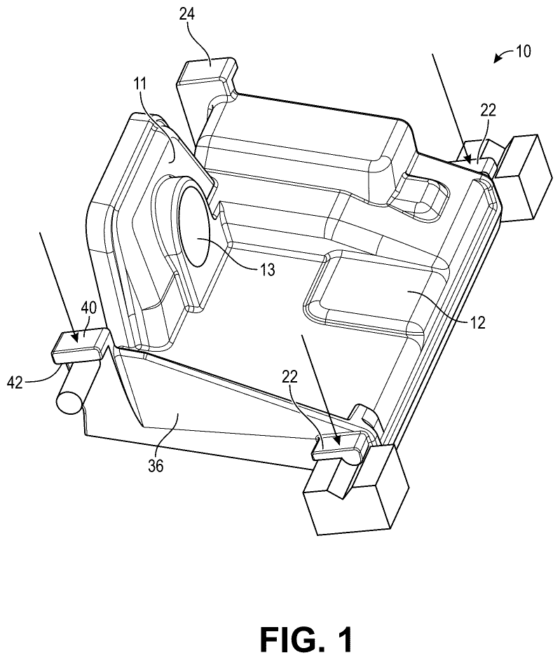

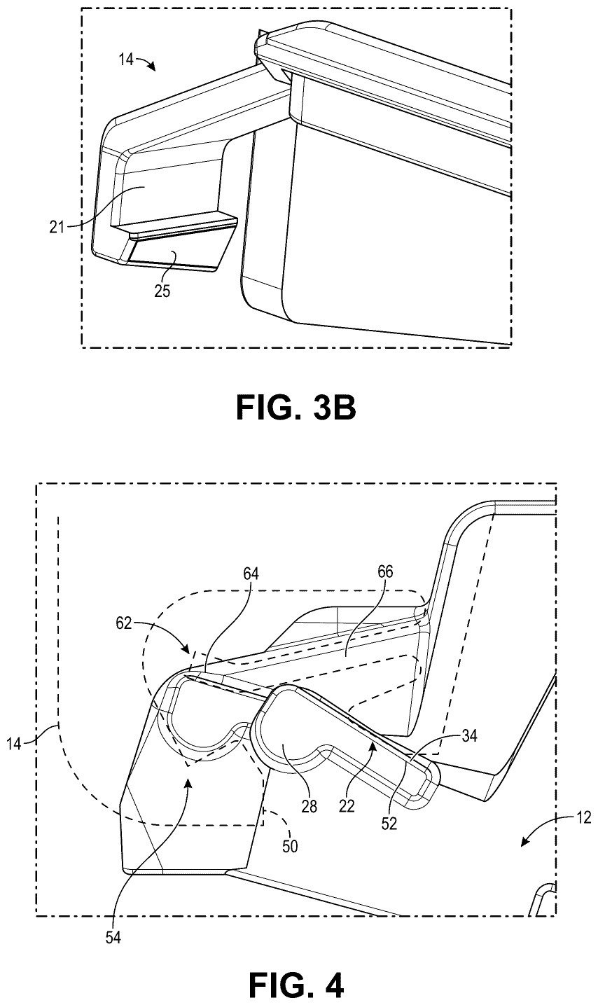

An exemplary arrangement of a vehicle sensor system 10 constructed in accordance with the present disclosure is shown in FIGS. 1-4. The vehicle sensor system 10 comprises a housing 12 secured in a mounting bracket 14 (shown in FIG. 3, for example). A camera or other sensor is mounted within the housing 12. For example, in one exemplary arrangement, the housing includes a rear mounting flange 11 that includes an opening therethrough 13, through which a camera lens (not shown) may protrude. Once positioned within the housing 12, the camera is operatively connected to data processing circuitry (not shown) within the camera housing 12 for processing any image within the field of view of the camera. The circuitry within the housing 12 is connectable with other vehicle systems. For the purposes of explanation, in one exemplary arrangement, the vehicle sensor system 10 is a forward looking system and may be mounted to a window of a vehicle, such as a front windshield. The vehicle sensor system 10 views the environment outside of the vehicle and analyzes monitored information for vehicle functions, such as lane keeping, roadway departures, pedestrian information, road sign information, etc. The analyzed information is then further processed and used by vehicle control systems and/or warning systems. Those skilled in the art will appreciate that the present disclosure is applicable to other vehicle sensor systems such as a rearward facing system for monitoring the environment rearward of the vehicle, as well as other mountable vehicle sensor systems.

The mounting bracket 14 is connectable to a window in any desired manner. For example, the mounting bracket 14 may have a mounting portion 16 that is connectable to the window (such as by adhesive or other suitable methods) and least one sidewall 18 that extends from the mounting portion 16 away from the window when the mounting bracket 14 is connected to the window. In one exemplary arrangement, the mounting bracket 14 has a pair of sidewalls 18 such that each sidewall 18 extends on an opposite sides of the housing 12 when the housing 12 is connected to the bracket 14.

Referring to FIG. 3A, each of the sidewalls 18 has a forward channel or slot 20. The mounting bracket 14 may also include locking arms, such as, for example rear locking arm 21, shown in FIG. 3B. In one exemplary arrangement, a pair of rear locking arms 21 are provided, one on each side of the mounting bracket 14. The rear locking arm 21 may be configured similar to that shown in U.S. patent application Ser. No. 18/560,819, the contents of which is hereby incorporated by reference in its entirety.

The forward slot 20 on the mounting bracket 14 receives a forward or first mounting element 22 that is disposed on the housing 12. In one exemplary arrangement, the housing 12 may have a pair of forward mounting elements 22 extending from opposite sides of the housing 12. Further, the forward mounting elements 22 may be integrally formed with the housing 12. Alternatively, the forward mounting elements 22 may be fixedly secured to the housing 12 by any suitable method.

The rear locking arms 21 engage rearward or second mounting elements 24 (best seen in FIG. 1) on the housing 12. In one exemplary arrangement, the second mounting elements 24 are configured as rectangular tabs. The housing 12 may have two second mounting elements 24 that extend from opposite sides of the housing 12. Correspondingly, a pair of rear locking arms 21 are also provided. To secure the second mounting elements 24 within the rear channel 21, a detent 25 may be provided. The detent 25 engages at least one of the second mounting elements 24 to connect the 12 to the bracket 14.

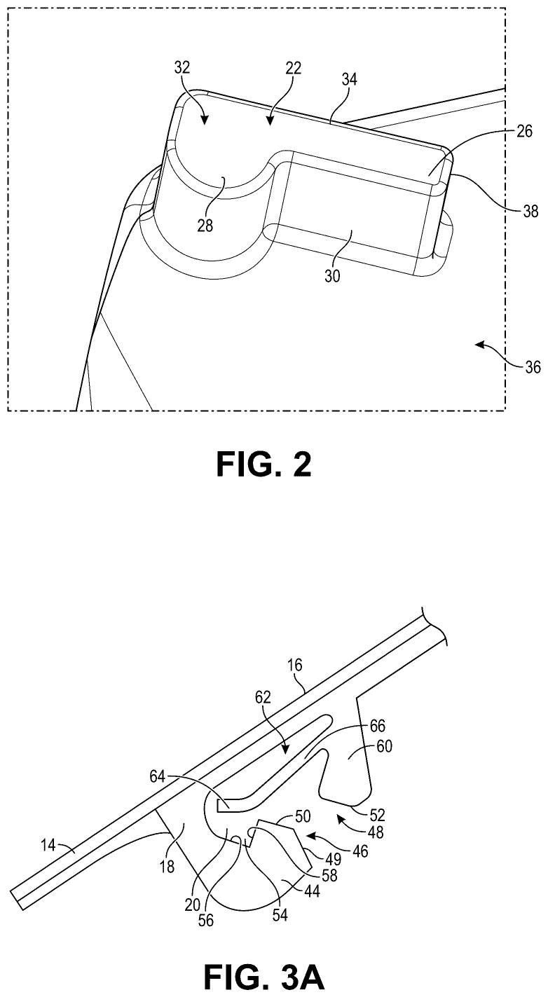

The forward mounting elements 22 will be described in greater detail in connection with FIG. 2. The forward mounting elements 22 include a leg portion 26 connected to a curved portion 28 that extends below a bottom surface 30 of the leg portion 26. The curved portion 28 is located at a forward end 32 of the forward mounting element 22. A top surface 34 of the forward mounting element 22 is generally planar across both the curved portion 28 and the leg portion 26.

The forward mounting elements 22 are fixedly secured to a sidewall 36 of the housing 12 and extends outwardly from the sidewall 36. The forward mounting element 22 is positioned at an angle such that the forward end 32 is positioned higher than a rearward end 38, when the housing is in a pre-engaged configuration.

The second mounting elements 24 have upper surfaces 40 and lower surfaces 42 that extend generally parallel to each other. The top surfaces 34 and the bottom surfaces 30 of the first mounting elements 22 may extend generally parallel to the upper surfaces 40 and lower surfaces 42 of the second mounting elements 24.

Referring to FIG. 3A, the forward slots 20 are at least partially defined by arms 44 extending from the sidewalls 18 of the bracket 14. Only one arm 44 of the bracket 14 will be described in detail. The arm 44 has an end portion 46 that partially defines an insertion opening 48 that faces generally downwardly. In one exemplary arrangement, the end portion 46 of the arm 44 includes a first direction surface 49 and a second direction surface 50. The second direction surface 50 extends generally parallel to a guide surface 52 on the sidewall 18 of the bracket 14 to help define the insertion opening 48. A V-shaped notch 54 in the arm 44 is defined by first and second side surfaces 56 and 58 that extend at an angle to one another. In one exemplary arrangement, the second side surface 58 of the notch 54 extends generally transverse to the second direction surface 50, while the first side surface 56 is positioned to be generally parallel to the second direction surface 50.

Extending from the sidewall 18 adjacent a rearward end 60 of the sidewall 18 is a finger element 62. The finger element 62 includes an end portion 64 extending upwardly from an angle of a base portion 66. The finger element 62 exerts a biasing force in a downward direction, toward the V-shaped notch 54, as will be explained below in further detail.

After the mounting bracket 14 is secured to a window or windshield, the housing 12 is snapped into the bracket by first inserting the forward mounting element 22 into the associated forward slot 20 and then pivoting the rear end of the housing 12 into the engagement with the rear locking arm 21 such that the rear locking arm 21 can be locked onto the associated second mounting elements 24 of the housing 12.

The forward mounting elements 22 are inserted into the insertion openings 48 with the second mounting elements 24 spaced from the rear locking arms. As shown in FIG. 4, the forward mounting elements 22 are advanced through the insertion openings 48 until the forward end 32 contacts the finger element 62. The forward mounting elements 22 continue to be advanced until the finger element 62 is deflected upwardly until the curved portion 28 of the forward mounting element 22 is moved past the second direction surface 50. The top surface 34 of the forward mounting element 22 is guided along the guide surface 52. Once the curved portion 28 clears the second direction surface 50, the finger element 62 will bias the curved portion 28 into engagement with the V-shaped notch 54 and retain the curved portion 28 therewithin, thereby locking the forward mounting elements 22 to the mounting bracket 14.

After insertion of the forward mounting elements 22 into the forward slots 20, the housing 12 may be pivoted relative to the bracket 14, thereby moving the second mounting elements 24 toward the rear locking arms 21 as the housing 12 is pivoted relative to the bracket 14. The forward mounting elements 22 may rotate within the notch 54, while being retained within the notch 54. Accordingly, the housing 14 is pivoted with the forward mounting elements 22 being seated within the slot 20 until the second mounting elements 24 engage the rear locking arms 21.

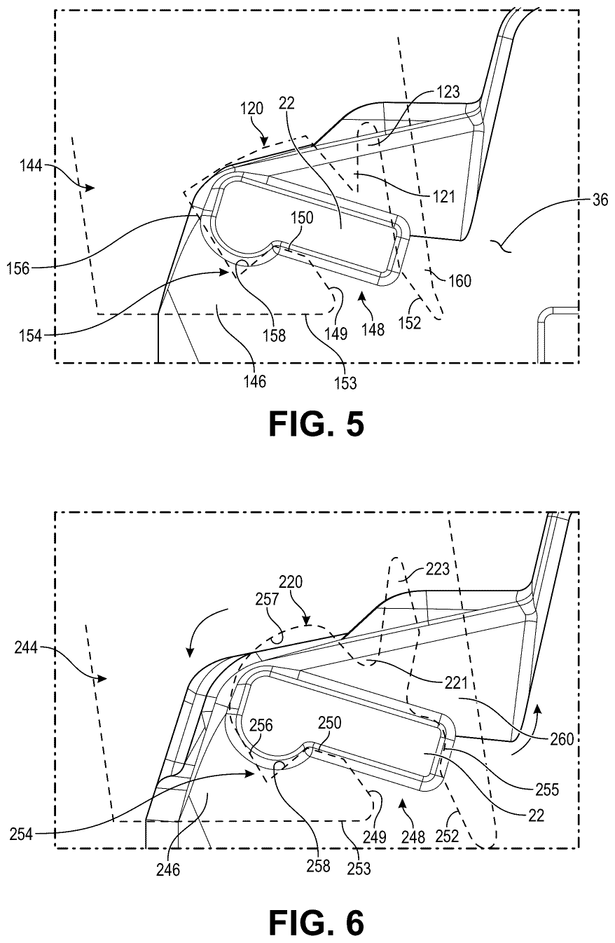

Referring to FIG. 5, an alternative configuration of a forward slot 120 is shown. The forward slot 120 also includes a V-shaped notch 154, formed by the same first and second side surfaces 156 and 158, as shown in FIG. 3A. An insertion opening 148 is formed by the first direction surface 149 on the end portion 146 of the arm 144 and the guide surface 152. The guide surface 152, which is formed on a rearward end 160 of the sidewall 18, extends to the bottom surface 153 of the forward end 146.

Unlike the arrangement in FIG. 3A, the arrangement in FIG. 5 does not include a finger element 62. Instead, the slot 120 is shaped with an inverted section 121. The inverted section 121 extends into the open area of the slot 120, leaving a channel 123 disposed between the inverted section and the rearward section 160, such that the inverted section 121 is positioned adjacent the rearward section 160 of the sidewall 18. The inverted section 121 serves to exert a biasing force in a downward direction, on the forward mounting element 22.

In operation, the forward mounting elements are inserted into the insertion openings 148 and advanced through the insertion openings 148 until the forward end 32 of the forward mounting element 22 is moved past the second direction surface 150. The top surface 34 of the forward mounting element 22 is guided along the guide surface 52. Once the curved portion 28 clears the second direction surface 150, the inverted section 121 will bias the forward mounting element against the second direction surface 150, such that the curved portion 28 will remain in engagement with the V-shaped notch 154 and retain the curved portion 28 therein, thereby locking the forward mounting elements 22 to the mounting bracket 14.

The exemplary arrangement shown in FIG. 6 is similar to that shown in FIG. 5. More specifically, the arrangement in FIG. 6, also includes a forward slot 220 with a V-shaped notch 254 formed by the same first and second side surfaces 256 and 258 as shown in FIG. 5. An insertion opening 248 is formed by the first direction surface 249 on the end portion 246 of the arm 244 and the guide surface 252. The guide surface 252, which is formed on a rearward end 260 of the sidewall 18, extends beyond a bottom surface 253 of the forward end 246.

Unlike the arrangement in FIG. 5, the arrangement in FIG. 6 further includes an indentation 255 formed in the guide surface 252 of the rearward end 260. The indentation 255 extends inwardly from the guide surface 252 away from V-shaped notch 254. The slot 220 also includes an inverted section 221 that extends slightly into the open area of the slot 220, leaving a channel 223 disposed between the inverted section 221 and the rearward section 260.

In operation, the forward mounting elements are inserted into the insertion openings 248 and advanced through the insertion openings 248 until the forward end 32 of the forward mounting element 22 reaches a top wall 257 of the slot 220 and past the second direction surface 250. Once in this position, the forward end 32 will be positioned above the V-shaped notch 254. Next, once fully inserted, the bracket 14 will be pivoted with respect to the housing 12 (see arrows) such that forward end 32 of the forward mounting elements 22 will be directed into the V-shaped notch 254 and the leg member 34 will be forced into the indentation 255, thereby locking the forward mounting elements 22 to the mounting bracket 14.

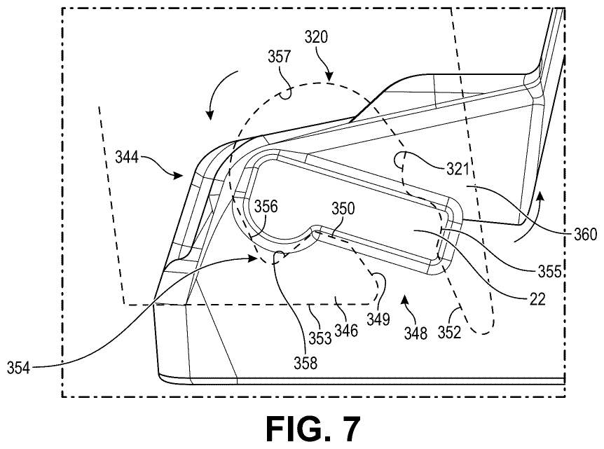

The arrangement shown in FIG. 7 is similar to that shown in FIG. 6. More specifically, the arrangement in FIG. 7 also includes a forward slot 320 with a V-shaped notch 354 formed by the same first and second side surfaces 356 and 358 as shown in FIG. 6. An insertion opening 348 is defined by the first direction surface 349 on the end portion 346 of the arm 344 and the guide surface 352. The guide surface 352, which is formed on a rearward end 360 of the sidewall 18, extends beyond a bottom surface 353 of the forward end 346.

The arrangement in FIG. 7 further includes an indentation 355 formed in the guide surface 352 of the rearward end 360. The indentation 355 extends inwardly from the guide surface 352 away from V-shaped notch 354. Formed above the indentation 355 is a stop 321 that bulges outwardly from the rearward end 360. The slot 320 has a mushroom cap shape.

In operation, the forward mounting elements 22 are inserted into the insertion openings 348 and advanced through the insertion openings 348 until the forward end 32 of the forward mounting element 22 reaches a top wall 357 of the slot 320 and passes the second direction surface 350. Once in this position, the forward end 32 will be positioned above the V-shaped notch 354. Next, once fully inserted, the bracket 14 will be pivoted with respect to the housing 12 (see arrows) such that forward end 32 of the forward mounting elements 22 will be directed into the V-shaped notches 354 and the leg members 34 will be forced into the indentations 355, thereby locking the forward mounting elements 22 to the mounting bracket 14.

What have been described above are examples of the present disclosure. It is, of course, not possible to describe every conceivable combination of components or methodologies for purposes of describing the present invention, but one of ordinary skill in the art will recognize that many further combinations and permutations of the present invention are possible. While certain novel features of this disclosure shown and described below are pointed out in the annexed claims, the disclosure is not intended to be limited to the details specified, since a person of ordinary skill in the relevant art will understand that various omissions, modifications, substitutions and changes in the forms and details of the disclosure illustrated and in its operation may be made without departing in any way from the spirit of the present disclosure. Accordingly, the present disclosure is intended to embrace all such alterations, modifications, and variations that fall within the scope of the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements. No feature of the disclosure is critical or essential unless it is expressly stated as being “critical” or “essential.”

What is claimed is:

1. A mounting arrangement for a vehicle sensor, comprising:
a housing having a vehicle sensor mounted therein, the housing having at least one mounting element; and
a mounting bracket including at least one locking arm that includes a slot for receiving the at least one mounting element, wherein the slot includes a V-shaped notch therein to retain the at least one mounting element within the slot.

2. The mounting arrangement of claim 1, wherein the at least one mounting element includes a leg portion connected to a curved portion, wherein the curved portion is receivable within the V-shaped notch when the at least one mounting element is in an engaged position.

3. The mounting arrangement of claim 2, wherein the curved portion extends below a bottom surface of the leg portion.

4. The mounting arrangement of claim 2, wherein a top surface of the at least one mounting element is generally planar across both the curved portion and the leg portion.

5. The mounting arrangement of claim 1, wherein the at least one mounting element is fixedly secured to a sidewall of the housing so as to extend outwardly from a surface of the sidewall.

6. The mounting arrangement of claim 1, wherein the at least one mounting element includes a forward mounting element and a rear mounting element.

7. The mounting arrangement of claim 6, wherein the rear mounting element is defined by upper surface and lower surfaces that extend generally parallel to each other.

8. The mounting arrangement of claim 1, wherein the slot is partially defined by a forward arm extending from a sidewall of the bracket and wherein the arm has an end portion that partially defines an insertion opening that faces downwardly.

9. The mounting arrangement of claim 8, wherein the end portion includes a first direction surface and a second direction surface, wherein the second direction surfaces extends generally parallel to a guide surface on the sidewall of the bracket to define the insertion opening.

10. The mounting arrangement of claim 1, wherein the V-shaped notch is defined by first and second side surfaces that extends at an angle to one another.

11. The mounting arrangement of claim 10, wherein the first and second side surfaces are arranged at a 90° to one another.

12. The mounting arrangement of claim 1, wherein a finger element extends into the slot from a rearward end of a sidewall of the bracket, wherein the finger element exerts a biasing force in a downward direction toward the V-shaped notch.

13. The mounting arrangement of claim 1, wherein the vehicle sensor is a camera.

14. The mounting arrangement of claim 1, wherein in a rearward end of the sidewall, an engagement groove is formed, wherein a rearward end of the at least one mounting element engages with the engagement groove when the at least one mounting element is in an engagement position.

15. The mounting arrangement of claim 14, wherein a stop is formed above the engagement groove.

16. A mounting arrangement for a vehicle sensor, comprising:
a housing having a camera mounted therein, the housing having a pair of forward mounting elements, one disposed on each side of the housing, and having a pair of rear mounting elements, one disposed on each side of the housing; and
a mounting bracket including at least one locking arm disposed on each side of the mounting bracket, each locking arm including a slot for receiving one of the forward mounting elements, wherein the slots each include a V-shaped notch therein to retain the forward mounting element within the slot.

17. The mounting arrangement of claim 15, wherein the forward mounting elements each include a leg portion connected to a curved portion, wherein the curved portion is receivable within the V-shaped notch when the forward mounting element is in an engaged position.

18. The mounting arrangement of claim 15, wherein the forward mounting elements are fixedly secured to a sidewall of the housing so as to extend outwardly from a surface of the sidewall.

19. The mounting arrangement of claim 17, wherein the slot is partially defined by an arm extending from the sidewall of the bracket and wherein the arm has an end portion that partially defines an insertion opening that faces downwardly.

20. The mounting arrangement of claim 18, wherein a finger element extends into the slot from a rearward end of the sidewall of the bracket, wherein the finger element exerts a biasing force in a downward direction toward the V-shaped notch.
